(19) United States
(12) Patent Application Publication
(10) Pub. No.: US 2026/0084087 A1
(43) Pub. Date: Mar. 26, 2026

(54) Dryer And Method For Drying A Gas Flow In A Carbon Dioxide Separation Plant

(71) Applicant: Volkswagen Aktiengesellschaft, Wolfsburg (DE)

(72) Inventors: Martin HOFER, Braunschweig (DE); Marcel WIEGEL, Gardelegen / OT Sachau (DE); Peter KAWELKE, Wolfsburg (DE); Frank BEGER, Hannover (DE); Christian HEIMERMANN, Wolfsburg (DE)

(73) Assignee: Volkswagen Aktiengesellschaft, Wolfsburg (DE)

(21) Appl. No.: 19/197,546

(22) Filed: May 2, 2025

(30) Foreign Application Priority Data
May 29, 2024 (DE) 102024115078.5

(51) Int. Cl. B01D 53/04; B01D 53/26

(52) U.S. Cl. CPC B01D 53/0415; B01D 53/0438; B01D 53/0446; B01D 53/261; B01D 2253/108; B01D 2257/504; B01D 2257/80; B01D 2259/40086; B01D 2259/40088

(57) ABSTRACT

The disclosure relates to a dryer for a plant for separating carbon dioxide from a gas flow. The dryer comprises a housing, multiple drying modules, a carrier arranged in the housing of one of the drying modules for receiving multiple drying cartridges, and multiple drying cartridges received in the carrier. The housing has at least one inlet flap for closing an inlet opening and at least one outlet flap for closing an outlet opening. The dryer further comprises a gas distribution structure which divides a gas flow through the dryer. The disclosure also relates to a plant for separating carbon dioxide from a gas flow having such a dryer for drying the gas flow prior to the separation of the carbon dioxide, and to a method for separating carbon dioxide from a gas flow, in which the gas flow is dried prior to the separation of the carbon dioxide.

### CROSS-REFERENCE TO RELATED APPLICATIONS

This application claims priority to German Patent Application DE 10 2024 115 078.5, filed on May 29, 2024 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a device and a method for drying a gas flow in a plant for separating carbon dioxide from a gas flow, in particular from the ambient air, and to such a plant according to the preamble of the independent patent claims.

Plants and methods for separating carbon dioxide from the ambient air are known. Such separation can be carried out using the so-called “direct air capture method”, in which the carbon dioxide can be separated directly from the ambient air, stored, or fed to a further process. Carbon dioxide can be separated from the ambient air using different sorbents.

In order to achieve efficient separation of carbon dioxide from the ambient air, carbon dioxide separation plants may be operated using renewable energies, in particular hydropower, wind power, geothermal energy, or solar energy. Operation with hydropower would be beneficial, since this can be provided continuously and reliably. However, the potential for generating energy from hydropower is limited to corresponding river courses and is already almost fully utilized in many regions, and therefore expansion of the use of hydropower is limited. Solar energy and wind power can essentially be used regardless of location, but their use is limited by the orbit of the sun and/or the weather conditions at the location.

Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive. Physisorbents, such as zeolites, have the problem that the affinity of the sorbent material for water (vapor) is higher than for carbon dioxide, which means that the ambient air must first be dried before being fed to an adsorption chamber in which the zeolite material is arranged.

### SUMMARY

A need exists to improve the drying process. The need is addressed by the subject matter of the independent claim(s). Embodiments of the invention are described in the dependent claims, the following description, and the drawings.

### BRIEF DESCRIPTION OF THE DRAWINGS

FIG. 1 shows an example plant for separating carbon dioxide from a gas flow having a dryer;

FIG. 2 is a schematic representation of an example embodiment of a drying module of an example dryer when drying a main air flow;

FIG. 3 shows the drying module shown in FIG. 2 during heat displacement for heating up the drying module;

FIG. 4 shows the drying module shown in FIG. 2 and FIG. 3 during regeneration of the desiccant contained in the drying cartridges of the drying module;

FIG. 5 shows an example dryer and an example gas distribution structure for distributing a gas flow within the dryer;

FIG. 6 is a schematic representation of an air flow through an example dryer;

FIG. 7 is a further schematic representation of an air flow through an example dryer;

FIG. 8 is a flow chart for an example method for drying a gas flow in a plant for separating carbon dioxide from the dried gas flow; and

FIG. 9 shows an example dryer having multiple drying modules, in which the energy efficiency is increased by means of heat displacement within the dryer.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a dryer is provided for a plant for separating carbon dioxide from a gas flow, in particular an air flow. The dryer comprises multiple drying modules, also referred to as ‘drying enclosures’, that are interconnected depending on the process status. Each drying module comprises a housing, a carrier arranged in the housing for receiving multiple drying cartridges, and multiple drying cartridges received in the carrier. The housing has at least one inlet flap for closing an inlet opening and at least one outlet flap for closing an outlet opening. The dryer further comprises a gas distribution structure which divides a gas flow through the dryer.

The dryer according to some embodiments allows for a uniform flow to the drying cartridges in the dryer and thus particularly efficient drying of a gas flow guided through the dryer. Furthermore, the dryer allows for a low flow resistance and thus a low pressure drop when a flow flows through the drying modules of the dryer, which can reduce the conveying capacity for the gas flow. The gas distribution structure also makes it possible to efficiently displace the regeneration heat from one drying module to another drying module in the dryer, which can further increase the energy efficiency of the dryer.

In some embodiments, it is provided that multiple drying cartridges are arranged one above the other and/or one next to the other in the carrier. This allows for particularly efficient drying of the gas flow with low energy consumption. Since the gas flow flows in a uniform manner through the drying cartridges, the desiccant contained in the drying cartridges is substantially evenly loaded with moisture, such that the drying cartridges ensure the best possible dehumidification of the gas flow.

In some embodiments, it is provided that a gas distribution structure is arranged above the drying cartridges. For a space-saving arrangement of multiple drying modules within the dryer, the inlet and outlet for the heat displacement gas flow may be on the same end face of the drying module housings. The gas distribution structure allows for uniform flow through the drying cartridges for this flap arrangement. In addition, the available installation space may be utilized efficiently if the gas distribution apparatus is arranged above the drying cartridges of the dryer.

According to some embodiments, it is provided that the gas distribution structure has an inlet side and an outlet side, wherein the inlet side and the outlet side are connected to one another by two or more connecting ducts. This makes it easy to improve the flow through the dryer, thereby improving heat dissipation and heat recovery from the drying cartridges of the dryer. The air flow is guided in such a way that it is directed through the sorbent bed in order to pass from the inlet side to the outlet side.

In some embodiments, it is provided that the housing of the dryer has an inlet side and an outlet side, wherein a first inlet flap and/or a second inlet flap are arranged on the inlet side and a first outlet flap and/or a second outlet flap are arranged on the outlet side. This allows for large opening cross-sections to be realized on the inlet and outlet side, which enables a flow-optimized, low-resistance flow through the dryer. Furthermore, a large opening cross-section can be realized by the flap, which facilitates a uniform flow of a gas flow to be dried through the dryer.

In some embodiments, it is provided that a separating plate is arranged downstream of the drying cartridges in the main flow direction of a gas flow through the housing of the dryer. A separating plate makes it possible to reduce cross flows, which improves the drying and/or regeneration of the drying material. Furthermore, a separating plate allows for an air flow to be divided between two halves of the dryer, which improves heat recovery in a heat displacement air mode.

In some embodiments, it is provided that at least one purge air inlet is formed on an outlet side of the housing and at least one purge air outlet is formed on the inlet side. This makes it easy to guide a purge air flow through the dryer, which runs in the opposite direction to the main air flow in order to separate the moisture from the gas flow. This allows for simple and efficient regeneration of the desiccant in the drying cartridges, allowing the plant/system to be prepared for renewed drying of a gas flow.

In some embodiments, it is further provided that the dryer has a heat exchanger for heating the sorbent material. This allows for particularly efficient heating and regeneration of the sorbent material.

It may be beneficial in some embodiments if an inlet and an outlet for the heat displacement are formed on a side wall of the housing that is different from the inlet side and the outlet side. This allows for a particularly compact design of the dryer. In addition, connecting the heat displacement air to a side wall reduces the flow resistance of the main flow and improves the even distribution of the air to the sorbent cartridges, since larger inlet cross-sections are available for the main air flow.

In some embodiments, it is provided that a first flow manipulation element is arranged between an inlet opening and the carrier. This allows the gas flow to be divided and/or diverted accordingly, such that an even more uniform flow through the drying cartridges is achieved or the gas flow can be diverted to specific regions of the dryer in a targeted manner.

Some embodiments related to a system, also referred to as ‘plant’, for separating carbon dioxide from a gas flow, in particular from an air flow, having a dryer as described herein. A plant of this kind allows for particularly efficient drying of a gas flow, whereby a dried gas flow can be provided for the separation of carbon dioxide.

In some embodiments, it is provided that the plant has a preconditioner, also referred to as a ‘preconditioning unit’ herein, connected upstream of the dryer in the direction of flow of a main air flow through the plant, a sorption unit, also referred to as a ‘sorption enclosure’, connected downstream of the dryer, and a conveyor, also referred to as a ‘conveying element’, for conveying a gas flow through the plant. This allows for particularly efficient separation of carbon dioxide from the gas flow. In particular, the yield of separated carbon dioxide and the energy efficiency can be increased in a plant for separating carbon dioxide from the ambient air that uses a physisorbent.

In some embodiments, it is provided that the plant has storage, also referred to as ‘storage unit’ herein, downstream of the sorption unit for absorbing the carbon dioxide separated in the sorption unit. This makes it possible to store the carbon dioxide, wherein the carbon dioxide can be stored permanently and/or fed to a manufacturing process as a raw material.

Some embodiments relate to a method for drying a gas flow in a plant for separating carbon dioxide from a gas flow, in particular from an air flow, having such a dryer, which method comprises:

Operating the dryer in a first operating state, in which a main air flow is guided through the dryer in a main flow direction, wherein the contained moisture is at least partially removed from the main air flow in at least a first drying module of the drying cartridges,
Operating the dryer in a second operating state, in which a gas flow heated with waste heat from another drying module circulates through the dryer in such a way that at least some of the heat contained in the gas flow is used to preheat the drying material in a further drying module, and
Operating the dryer in a third operating state, in which a purge air flow flows through the dryer in a purge air flow direction opposite to the main flow direction and the moisture absorbed in the drying cartridges is at least partially discharged again from the drying cartridges.

The method allows for particularly energy-efficient drying of a gas flow, in particular an air flow, in a plant for separating carbon dioxide from a gas flow.

In some embodiments, it is provided that the dryer is operated in a fourth operating state, in which a cold, dry gas flow flows through a drying module in such a way that at least some of the heat contained in the sorbent material is dissipated from the drying module for further use. This allows for at least partial recovery of the process heat required for the drying process, which can further improve the energy efficiency of the method.

In some embodiments, it is provided that the dried main air flow is fed to a sorption unit and the carbon dioxide contained in the dried main air flow is separated from the main air flow in the sorption unit. Prior drying can further increase the yield and energy efficiency when separating carbon dioxide from the gas flow.

In some embodiments, it is provided that the exhaust air from the sorption unit, in which the carbon dioxide is separated from the ambient air, is fed to the dryer in order to regenerate the drying modules of the dryer and to expel the moisture bound in the drying modules. The heat displacement within the dryer is used to achieve the most energy-efficient drying possible of the main air flow as well as parallel regeneration of drying modules within the dryer.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. The FIG. is schematic and not necessarily to scale.

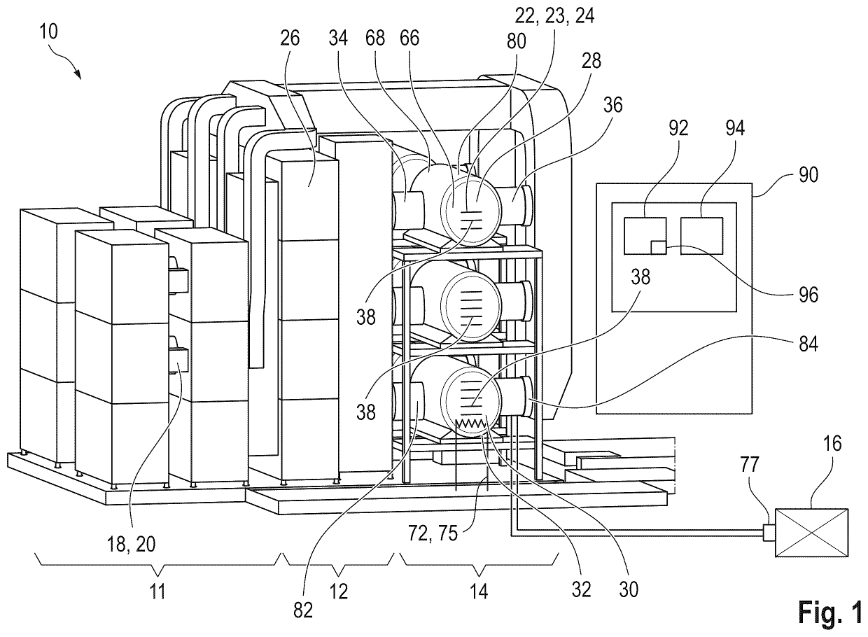

FIG. 1 shows a plant/system 10 for separating carbon dioxide from a gas flow, in particular from the ambient air. A gas flow having a particular residual moisture content is fed to the plant 10 and carbon dioxide and water vapor are removed from this gas flow. An exhaust air flow flows out of the plant 10, which has a gas that is dried and reduced in terms of carbon dioxide compared to the incoming gases. The plant 10 comprises a preconditioning unit 11, in which a gas flow is filtered and pre-dried. For this purpose, the preconditioning unit 11 contains at least one filter unit and one dryer in order to prepare a gas flow for further processing in the plant 10. Furthermore, the preconditioning unit 11 includes a conveying element 18, in particular a blower 20, for generating such a gas flow and to convey the ambient air through the plant 10.

The plant 10 also comprises a dryer 12, in which the residual moisture contained in the gas flow is at least partially removed. For example, a hydrophilic material such as silica gel can be used as a desiccant for the dryer 12. In principle, any drying material that is suitable for absorbing moisture from the air can be used. In particular, a sorbent material 22, in particular a physisorbent 23, may also be provided as a desiccant in the dryer 12. For example, a desiccant is used which can be regenerated and fed back into the process by means of appropriate process control after the moisture in the air has been absorbed. The aim is to achieve a degree of drying of the gas flow at which the residual moisture in the air has a dew point of at most-30° C., or for example−50° C., or for example at most−60° C. dew point.

The plant 10 also comprises a sorption unit 14, in which the carbon dioxide from the gas flow, in particular from the ambient air, is bound. The carbon dioxide in the dried gas flow is stored in a sorbent material 22, in particular in a physisorbent 23, particularly for example in a zeolite material 24. The sorption unit 14 comprises one or more sorption modules 30, also referred to herein as ‘sorption subassemblies’, each having one or more sorbent beds 38, wherein the sorption modules 30 each have a cylindrical housing 32. Alternatively, the sorption modules 30 may also have geometries that deviate from a cylindrical shape. The housing 32 has a lateral surface 80, wherein an inlet opening 34 is formed on a first side 82 of the lateral surface 80 and an outlet opening 36 is formed on a second side 84 of the lateral surface 80 opposite the first side 82. The cylindrical housing 32 is also delimited by a first end face 66 and a second end face 68.

In addition, the plant 10 has a storage unit 16, in which the carbon dioxide separated from the gas flow in the sorption unit 14 is stored in concentrated form. Alternatively or additionally, the desorbed carbon dioxide may also be fed directly for further use or a gas flow may be divided, wherein some of the desorbed carbon dioxide is stored in the storage unit 16 and some is fed to a manufacturing process.

The gas flow is dried in a first process chamber 26, which may be separated from the environment in a substantially gas-tight manner by closure elements, in particular by flaps 50, 52, 54, 56. In the exemplary embodiment shown, the first process chamber 26 has two inlet flaps 50, 52 and two outlet flaps 54, 56. A heating element 72 may be arranged in the first process chamber 26 in order to manipulate the temperature of the desiccant in the dryer 12 or else in the first process chamber 26. Furthermore, sensors for detecting a temperature, a pressure, a carbon dioxide concentration, a flow velocity, and/or a relative or absolute humidity of the gas flow may be arranged in the first process chamber 26 or else in the dryer 12.

The adsorption and subsequent desorption of carbon dioxide for example takes place in a second process chamber 28, which may be separated from the environment in a substantially gas-tight manner by means of closure elements. Furthermore, the second process chamber 28 has a heating element, in particular a heat exchanger 75, in order to be able to raise the temperature accordingly, in particular during the desorption process, and to release the carbon dioxide adsorbed in the sorbent material 22. A vacuum pump 77 may be provided at the second process chamber 28, or else at the sorption unit 14, in order to manipulate the air pressure in the second process chamber 28 or a gas line connecting the second process chamber 28 to the storage unit 16 and, in particular, to lower it during a desorption process. The second process chamber 28 may be fluidically connected to the storage unit 16, in which the carbon dioxide separated from the ambient air can be stored. A temperature sensor, a pressure sensor, a humidity sensor, a sensor for detecting the carbon dioxide concentration, a sensor for detecting the flow velocity, a mass flow sensor, and/or a volume flow sensor are arranged in the second process chamber 28 or else in the sorption unit 14. Alternatively, the sorption unit 14 may also be connected to a consumer in which the separated carbon dioxide is further processed in a subsequent method step and, in particular, serves as a starting material for the production of a new substance.

The conveying element 18 for conveying a gas flow through the plant 10, in particular a blower 20, is for example arranged in the preconditioning unit 11 and integrated therein. The conveying element 18 has a drive unit whose power can be adjusted accordingly via a power controller. Alternatively, the conveying element 18 may also be arranged in a duct for feeding the air to the plant 10 or a duct for discharging the air from the plant 10.

The plant 10 is for example supplied with electricity from renewable energy sources such as wind or solar power, so as not to generate any additional carbon dioxide emissions during operation. For this purpose, a wind turbine and/or a solar plant, in particular a solar thermal plant or a photovoltaic plant, is provided to supply the plant with renewable energy.

The plant 10 further has a control unit 90 having a memory unit 92 and a computing unit 94, wherein a computer program code 96 is stored in the memory unit 92, which computer program code is configured, when executed by the computing unit 94 of the control unit 90, to control the operation of the plant 10 for separating carbon dioxide from the gas flow, in particular from the ambient air. The control unit 90 may be connected to a data center via a data connection, which data center provides the plant 10 with data for controlling the plant 10 or exchanges data therewith.

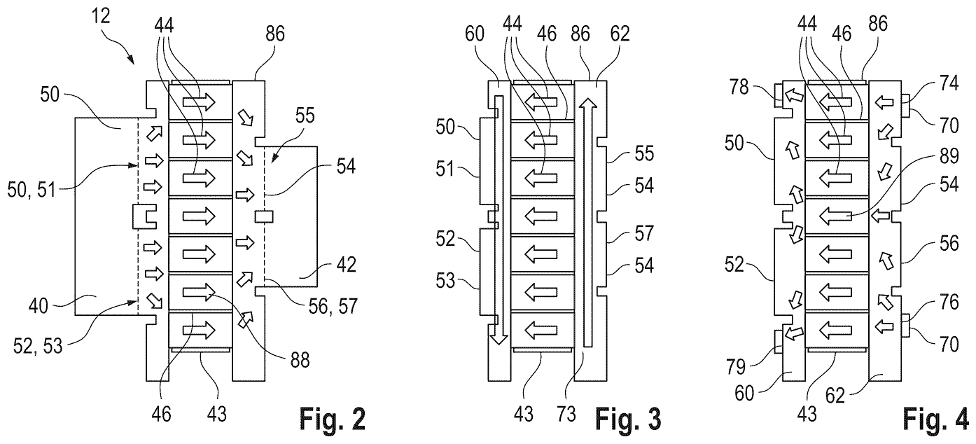

FIG. 2 shows an embodiment of a drying module 100, 102, 104, 106, 108, 110, 112, 114 of a dryer 12. The drying module 100, 102, 104, 106, 108, 110, 112, 114 has a housing 86 with an inlet side 40 and an outlet side 42 as well as side walls 43 formed between the inlet side 40 and the outlet side 42. Multiple drying cartridges 44 are arranged in the drying module 100, 102, 104, 106, 108, 110, 112, 114 of the dryer 12 and are received horizontally one above the other and/or vertically one next to the other in a common carrier 46.

An inlet flap 50 is formed on the inlet side 40, by means of which an inlet opening 51 can be opened or closed and through which a main air flow 88 can enter the dryer 12. Furthermore, a flow manipulation element 61 may be arranged between the inlet opening 51 and the drying cartridges 44, by means of which the main air flow 88 entering through the inlet opening 51 can be deflected and/or divided. The flow manipulation element 61 comprises multiple baffles 65, which deflect or divide the main air flow 88. In the operating state shown in FIG. 2, the dryer 12 is operated in a drying mode, in which moisture is removed from the main air flow 88 by the drying cartridges 44.

An outlet flap 54 is provided on the outlet side 42, by means of which an outlet opening 55 can be opened and closed and through which a main air flow 88 can exit the dryer 12. The drying module 100, 102, 104, 106, 108, 110, 112, 114 in FIG. 2 is shown during a drying process in which the moisture contained in the gas flow is adsorbed in the desiccant of the drying cartridges 44.

FIG. 3 shows the drying module 100, 102, 104, 106, 108, 110, 112, 114 shown in FIG. 2 during heat displacement, during which the drying module 100, 102, 104, 106, 108, 110, 112, 114 is heated by the waste heat from another drying module 100, 102, 104, 106, 108, 110, 112, 114 and/or the waste heat from the sorption unit 14.

The drying module 100, 102, 104, 106, 108, 110, 112, 114 has a housing 86 with an inlet side 40 and an outlet side 42 as well as side walls 43 formed between the inlet side 40 and the outlet side 42. Multiple drying cartridges 44 are arranged in the drying module 100, 102, 104, 106, 108, 110, 112, 114 and are received horizontally one above the other and/or vertically one next to the other in a common carrier 46.

Two inlet openings 51, 53 are formed on the inlet side 40, which can be opened or closed by a first inlet flap 50 and a second inlet flap 52 and which are closed in the process step shown. Furthermore, an inlet chamber 60 and an outlet chamber 62 are formed in the drying module 100, 102, 104, 106, 108, 110, 112, 114 and are used as a path for the heat displacement for recovering energy. The inlet opening 51 for the heat displacement in the outlet chamber 62 is arranged on the end face 43 and the outlet opening in the inlet chamber 60 is arranged on the same end face 43 in order to enable a compact design when interconnecting the individual drying modules 100, 102, 104, 106, 108, 110, 112, 114. Two outlet openings 55, 57 are formed on the outlet side 42, which can be opened or closed by a first outlet flap 54 and a second outlet flap 56 and which are closed in the process step shown.

In FIG. 4, the drying module 100, 102, 104, 106, 108, 110, 112, 114 shown in FIG. 2 and FIG. 3 is shown in a further operating state, in which the desiccant in the drying cartridges 44 is regenerated. In the operating state shown in FIG. 4, the drying module 100, 102, 104, 106, 108, 110, 112, 114 is operated in a purge air mode, in which a purge air flow 89 is guided through the dryer against the main flow direction of the main air flow 88 shown in FIG. 2, in order to discharge the moisture from the air absorbed in the drying cartridges 44.

The dryer 12 has a housing 86 with an inlet side 40 and an outlet side 42 as well as side walls 43 formed between the inlet side 40 and the outlet side 42. Multiple drying cartridges 44 are arranged in the dryer 12 and are received horizontally one above the other and/or vertically one next to the other in a common carrier 46.

Two inlet openings 51, 53 are formed on the inlet side 40, which can be opened or closed by a first inlet flap 50 and a second inlet flap 52 and which are closed in the purge process step or else during regeneration. Two outlet openings 55, 57 are formed on the outlet side 42, which can be opened or closed by a first outlet flap 54 and a second outlet flap 56 and which are closed in the purge process step shown.

The drying module 100, 102, 104, 106, 108, 110, 112, 114 has a first purge air inlet 74 and a second purge air inlet 76 on the outlet side 42, which are each covered by a perforated plate 70. The perforated plate 70 is attached as a baffle plate at a distance of 15% to 45%, for example 20% to 30% of the width of the inlet opening 51. A purge air flow 89 can be directed into the drying module 100, 102, 104, 106, 108, 110, 112, 114 through the purge air inlets 74, 76 in order to expel the moisture from the drying cartridges 44. The drying module 100, 102, 104, 106, 108, 110, 112, 114 also has a first purge air outlet 78 and a second purge air outlet 79 on the inlet side 40, through which the purge air flow 89 can be guided out of the drying module 100, 102, 104, 106, 108, 110, 112, 114 of the dryer 12 again after the moisture has been absorbed.

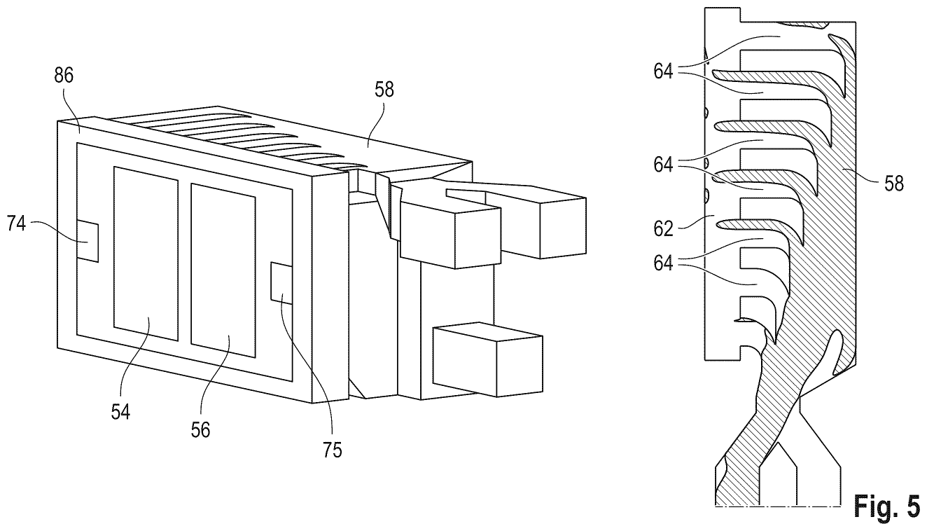

FIG. 5 shows a gas distribution structure 58 for a dryer 12, which is for example arranged above the drying cartridges 44 in the housing 86. In this case, the inflow and outflow of a gas flow guided through the gas distribution structure 58 takes place at a side wall 43 of the housing 86. The gas distribution structure 58 is designed to realize a flow through the drying modules 100, 102, 104, 106, 108, 110, 112, 114 that is as uniform as possible and to obstruct neither a main air flow 88 nor a purge air flow 89 through the drying modules 100, 102, 104, 106, 108, 110, 112, 114. This is achieved, in particular, by combining a 90° deflection of the heat displacement air flow with an additional separating plate 48. The deflection in the gas distribution structure 58 reduces the dynamic pressure in the rear region of the outlet chamber 62. The separating plate 48 prevents a return flow, such that the gas flow is first guided through the drying cartridges 44 of the relevant drying module 100, 102, 104, 106, 108, 110, 112, 114.

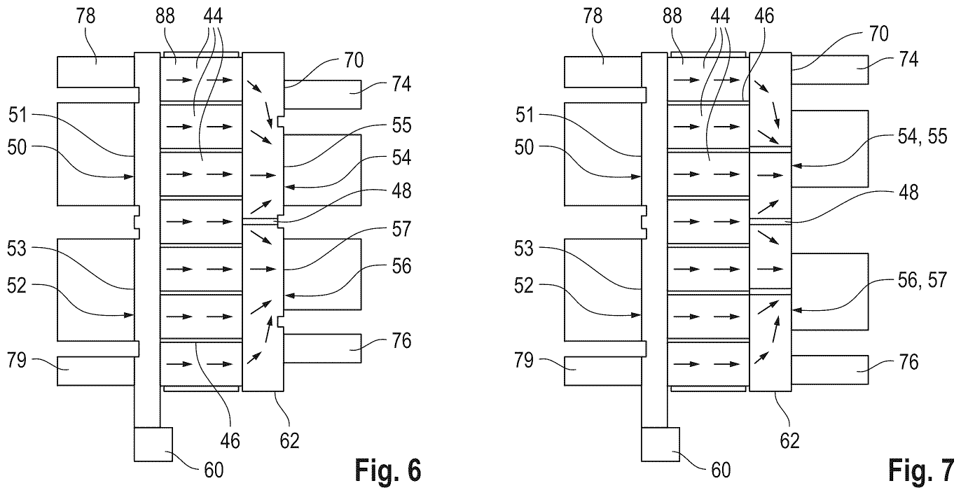

FIG. 6 shows a schematic representation of an air flow through a drying module 100, 102, 104, 106, 108, 110, 112, 114 of a dryer 12. A separating plate 48 is provided between the drying cartridges 44 and the outlet side 42 of the housing 86 in order to simplify the gas flow through the drying module 100, 102, 104, 106, 108, 110, 112, 114 and, in particular, to avoid cross flows. The outlet side 42 is divided into two halves, wherein each half has an outlet opening 55, 57 which can be closed by means of an outlet flap 54, 56 and has a purge air inlet 74, 76 in order to regenerate the relevant half of the dryer 12. This main air flow 88 through the drying module 100, 102, 104, 106, 108, 110, 112, 114 is not significantly disrupted by the separating plate 48.

FIG. 7 shows a further exemplary embodiment of an air flow during heat recovery by means of heat displacement in a dryer 12. With substantially the same structure as shown in FIG. 6, the outlet side is divided into four quarters in this exemplary embodiment. This enables better homogenization of the flow resistances during the flow through the dryer 12. In addition, a third purge air inlet is provided in this exemplary embodiment in order to be able to discharge the moisture from the central region of the dryer 12.

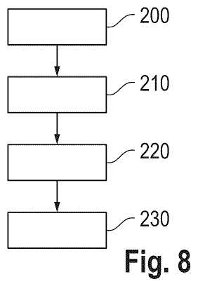

FIG. 8 shows a flow chart for a method for drying and subsequently separating carbon dioxide from a gas flow, in particular an air flow. In a method step <200>, the drying module 100, 102, 104, 106, 108, 110, 112, 114 is operated in a first operating state, in which a main air flow 88 is guided through the dryer 12 in a main flow direction, wherein the contained moisture is removed from the main air flow 88 at least partially in the drying cartridges 44, as strongly as possible, in particular to a dew point of −30° C., or for example to a dew point of −50° C., or for example to a dew point of −60° C. For this purpose, the inlet openings 51, 53 are opened by the inlet flaps 50, 52 and the outlet openings 55, 57 are opened by the outlet flaps 54, 56, such that the main air flow 88 can flow through the dryer 12 in the main flow direction for drying. The dried main air flow 88 is fed to the sorption unit 14, where the carbon dioxide contained in the dried main air flow is separated in the sorption modules 30.

In a method step <210>, the drying module 100, 102, 104, 106, 108, 110, 112, 114 is operated in a second operating state, in which a gas flow heated by the residual heat from another drying module 100, 102, 104, 106, 108, 110, 112, 114 circulates through the dryer 12 in such a way that at least some of the heat contained in the gas flow is used to preheat the desiccant. The gas flow is distributed by means of the gas distribution structure 58.

In a method step <220>, the drying module 100, 102, 104, 106, 108, 110, 112, 114 is operated in a third operating state, in which a purge air flow 89 flows through the dryer 12 in a purge air flow direction opposite to the main flow direction and the moisture absorbed in the drying cartridges 44 is at least partially discharged again from the drying cartridges 44. The purge air flow 89 flows into the dryer 12 through the first purge air inlet 74 and the second purge air inlet 76 and is discharged from the dryer 12 through the purge air outlets 78, 79. In addition, the desiccant is heated by the heat exchangers 75 located in the drying cartridges 44.

In a method step <230>, the drying module 100, 102, 104, 106, 108, 110, 112, 114 is operated in a fourth operating state, in which dry cold exhaust air from the sorption unit 14 flows through the drying module 100, 102, 104, 106, 108, 110, 112, 114. The heat dissipated via the fluid is fed to another drying module 100, 102, 104, 106, 108, 110, 112, 114, which is currently in method step <210>.

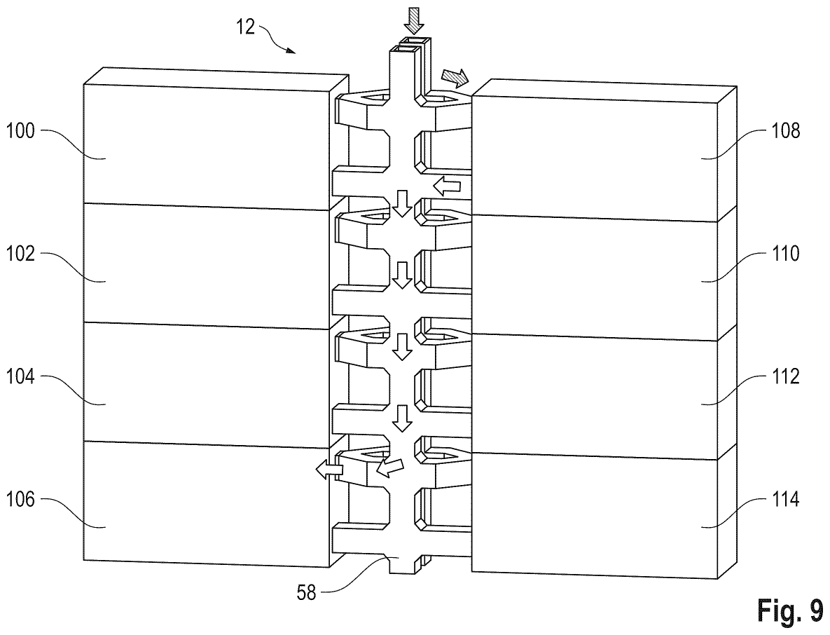

FIG. 9 shows a dryer 12 having eight drying modules 100, 102, 104, 106, 108, 110, 112, 114. However, the number of drying modules may also be larger or smaller depending on the design of the dryer 12. The individual process steps that take place in a drying module 100, 102, 104, 106, 108, 110, 112, 114 are shown below using the first drying module 100 of the dryer 12 as an example. At the start of the drying phase of the main air flow 88, the main air flow 88, which is at least partially dried, flows through the first drying module 100. This process step for example requires 50% of the total cycle time. The inlet and outlet flaps of the drying module 100 are then closed and the inlet and outlet flaps for the heat displacement of the drying module or else of the gas distribution structure 58 are opened. A preheated gas flow is introduced into the first drying module 100, which originates from dry exhaust air that has been preheated by the residual adsorption heat of the second drying module 102.

After the gas flow has transferred the heat to the drying cartridges 44 in the first drying module 100, the gas flow is released into the environment. In this process step, some of the moisture is already expelled from the desiccant in the drying cartridges 44. In addition, the drying cartridges 44 are heated by activating the heater.

In a further process step, the inlet flaps and outlet flaps for the heat displacement are closed and the inlet flaps and outlet flaps for the purge air flow 89 are opened. The majority of the water from the desiccant in the drying cartridges 44 is desorbed via the purge air flow 89 and released into the environment via the purge air outlet openings.

In a subsequent process step, the heat displacement flaps are opened again, wherein cold exhaust air from the sorption unit 14 flows through the drying module 100. The cold, dry air absorbs the heat from the drying cartridges 44 of the first drying module 100 and feeds it to the eighth drying module 114, which has just completed the drying phase. As a result, the drying modules 100, 102, 104, 106, 108, 110, 112, 114 cyclically run through the phases “adsorption”, “heating up”, “heat release”, and “desorption”, which results in a particularly high energy efficiency for the dryer 12.

### LIST OF REFERENCE NUMERALS

10 Carbon dioxide separation plant/system
11 Preconditioning unit/Preconditioner
12 Dryer
14 Sorption unit/Sorption enclosure
16 Storage unit/Storage
18 Conveyor element/Conveyor
20 Blower
22 Sorbent material
23 Physisorbent
24 Zeolite material
26 First process chamber
28 Second process chamber
30 Sorption module/Sorption subassembly
32 Housing
34 Inlet opening
36 Outlet opening
38 Sorbent bed
40 Inlet side
42 Outlet side
43 Side wall
44 Drying cartridge
46 Carrier
48 Separating plate
50 First inlet flap
51 First inlet opening
52 Second inlet flap
53 Second inlet opening
54 First outlet flap
55 First outlet opening
56 Second outlet flap
57 Second outlet opening
58 Gas distribution structure
60 Inlet chamber
61 Flow manipulation element
62 Outlet chamber
64 Connecting duct
65 Baffles
66 First end face
68 Second end face
70 Perforated plate
72 Heating element/Heater
74 First purge air inlet
75 Heat exchanger
76 Second purge air inlet
77 Vacuum pump
78 First purge air outlet
79 Second purge air outlet
80 Lateral surface
82 First side of the lateral surface
84 Second side of the lateral surface
86 Housing
88 Main air flow
89 Purge air flow
90 Control unit/Processor
92 Memory unit
94 Computing unit/Computer
96 Computer program code
100 First drying module/enclosure
102 Second drying module/enclosure
104 Third drying module/enclosure
106 Fourth drying module/enclosure
108 Fifth drying module/enclosure
110 Sixth drying module/enclosure
112 Seventh drying module/enclosure
114 Eighth drying module/enclosure

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A dryer for a system for separating carbon dioxide from a gas flow, comprising:
a housing;
multiple drying modules;
a carrier arranged in the housing of one of the drying modules for receiving multiple drying cartridges;
multiple drying cartridges received in the carrier;
at least one inlet flap for closing an inlet opening;
at least one outlet flap for closing an outlet opening; and
a gas distribution structure which divides a gas flow through the dryer.

2. The dryer of claim 1, wherein multiple drying cartridges are arranged in the carrier one above the other and/or one next to the other.

3. The dryer of claim 1, wherein the gas distribution structure is arranged above the drying cartridges.

4. The dryer of claim 1, wherein the gas distribution structure has an inlet chamber and an outlet chamber at a distance from the inlet chamber, wherein the inlet chamber and outlet chamber are interconnected by two or more connecting ducts.

5. The dryer of claim 1, wherein the housing of the dryer has an inlet side and an outlet side, wherein a first inlet flap and a second inlet flap are arranged on the inlet side and a first outlet flap and a second outlet flap are arranged on the outlet side.

6. The dryer of claim 1, wherein a separating plate is arranged in the center plane downstream of the drying cartridges in the main flow direction of a gas flow through the housing.

7. The dryer of claim 1, wherein at least one purge air inlet is formed on an outlet side of the housing and at least one purge air outlet is formed on the inlet side.

8. The dryer of claim 1, wherein the dryer has a heat exchanger for heating the drying material of a drying module of the dryer.

9. The dryer of claim 8, wherein an inlet and an outlet for carrying out heat displacement are formed on a side wall of the housing different from the inlet side and the outlet side.

10. The dryer of claim 1, wherein a flow manipulation element is arranged between an inlet opening and the carrier.

11. A system for separating carbon dioxide from a gas flow having the dryer of claim 1.

12. The system of claim 11, wherein the system has a preconditioner connected upstream of the dryer in the flow direction of a main air flow through the and a sorption unit connected downstream of the dryer as well as a conveyor for conveying a gas flow through the plant.

13. A method for drying a gas flow in a carbon dioxide separation system having the dryer of claim 1, the method comprising the:
operating the dryer in a first operating state, in which a main air flow is guided through the dryer in a main flow direction, wherein the contained moisture is at least partially removed from the main air flow in at least a first drying module;
operating the dryer in a second operating state, in which a gas flow heated with waste heat from another drying module circulates through the dryer in such a way that at least some of the heat contained in the gas flow is used to preheat the drying material in a further drying module; and
operating the dryer in a third operating state, in which a purge air flow flows through the dryer in a purge air flow direction opposite to the main flow direction and the moisture absorbed in the drying cartridges is at least partially discharged again from the drying cartridges.

14. The method of claim 13, wherein the dryer is operated in a fourth operating state, in which a cold, dry gas flow flows through a drying module in such a way that at least some of the heat contained in the sorbent material is dissipated from the drying module for further use.

15. The method of claim 13, wherein the main air flow is fed to a sorption unit and the carbon dioxide contained in the main air flow is separated from the main air flow in the sorption unit.

16. The method of claim 13, wherein multiple drying cartridges are arranged in the carrier one above the other and/or one next to the other.

17. The method of claim 13, wherein the gas distribution structure is arranged above the drying cartridges.

18. The method of claim 13, wherein the gas distribution structure has an inlet chamber and an outlet chamber at a distance from the inlet chamber, wherein the inlet chamber and outlet chamber are interconnected by two or more connecting ducts.

19. The method of claim 13, wherein the housing of the dryer has an inlet side and an outlet side, wherein a first inlet flap and a second inlet flap are arranged on the inlet side and a first outlet flap and a second outlet flap are arranged on the outlet side.

20. The method of claim 13, wherein a separating plate is arranged in the center plane downstream of the drying cartridges in the main flow direction of a gas flow through the housing.
